(19) United States
(12) Patent Application Publication
(10) Pub. No.: US 2008/0067727 A1
(43) Pub. Date: Mar. 20, 2008

(54) Stabilizer mount for coupling a stabilizer bar to a motor vehicle

(75) Inventors: Helge Schwarz, Garlstorf (DE); Andreas Hoper, Buxtehude (DE)

Correspondence Address: Davidson, Davidson & Kappel, LLC, 485 17th Avenue, 14th Floor, New York, NY, 10018, US

(73) Assignee: Carl Freudenberg KG, Weinheim (DE)

(21) Appl. No.: 11/825,281

(22) Filed: Jul. 5, 2007

(30) Foreign Application Priority Data
Jul. 14, 2006 (DE) 102006032826.4-21

(51) Int. Cl. B60G 21/055; F16F 1/38

(52) U.S. Cl. 267/141.1

(57) ABSTRACT

A stabilizer mount, in particular for coupling a stabilizer bar to a motor vehicle, said stabilizer mount including a bearing bushing which surrounds the bar, being made of an elastomer, having an axial slit, and which is embraced by a fixing clamp, the bearing bushing being retained in the clamp through the use of an outer mount part that is connectable to the clamp in form fitting relation therewith.

This application claims priority to German Patent Application DE 102006032826.4-21, filed Jul. 14, 2006, and hereby incorporated by reference herein.

The present invention relates to a stabilizer mount for coupling a stabilizer bar to a motor vehicle, the stabilizer mount including a bearing bushing which surrounds the bar, is made of an elastomer, has an axial slit, and which is embraced by a fixing clamp.

### BACKGROUND

Stabilizer mounts are used for coupling stabilizer bars in motor vehicle suspensions. They act as a connecting element between the stabilizer and the axle. The mounting heights required for the stabilizer mount vary depending on the attachment location. Therefore, adjustment parts are needed. Another problem arises when shipping the stabilizer mount itself. It is customary for the manufacturer of the stabilizer mount to assemble the same, together with the clamp. The preassembled component is then delivered to the axle manufacturer. At that point, if no safety precautions have been taken, the clamp can potentially pop off of the bearing bushing when the stabilizer mount is shipped.

From the German Patent Application DE 10 2004 056 884 A1, a stabilizer mount is known, whose bearing bushing manufactured from rubber is composed of two individual parts, one of the parts being permanently joined to the clamp, and the other rubber member being designed as a slip-on rubber member that is able to be detachably secured to the clamp. The two parts can be joined together by a snap-fit connection. The snap-fit connection allows preassembly of the two mount parts. However, this stabilizer mount has a very complex overall design, so that it is costly to manufacture.

Another stabilizer mount design is discussed in the German Patent Application DE 100 45 778 A1. Here, the bearing bushing made of rubber is supplemented by a base that is vulcanized thereto, and the two interconnected parts are embraced by the clamp. The bearing bushing has a lateral slit that extends in parallel to its longitudinal axis and is used as a mounting opening to allow the stabilizer bar to be introduced into the upwardly folded lip of the bearing bushing. In this specific embodiment, the manufacturing process is likewise complex, because a specially selected rubber mixture is used in a vulcanization process to join together the bearing bushing and the base made of plastic. Moreover, in this case as well, there is no assurance that the clamp will not pop off of the bearing bushing during shipping.

### SUMMARY OF THE INVENTION

An object of the present invention is to devise a stabilizer mount that is simple in its design and that is able to be inexpensively manufactured and readily assembled. Moreover, it is intended that any height adjustment required during assembly may be easily implemented, and also that a shipping brace be provided to ensure that the clamp does not come loose from the preassembled mount during shipping.

The present invention provides a stabilizer mount, in particular for coupling a stabilizer bar to a motor vehicle, the stabilizer mount including a bearing bushing which surrounds the bar, is made of an elastomer, has an axial slit, and which is embraced by a fixing clamp, wherein the bearing bushing is retained in the clamp through the use of an outer mount part that is connectable to the clamp in form fitting relation therewith. The present invention can immovably retain the bearing bushing in the clamp through the use of an outer mount part that is connectable to the clamp in form fitting relation therewith. Thus, the stabilizer mount can be preassembled by inserting the bearing bushing into the clamp and by pressing a correspondingly formed outer mount part into the remaining free space between the clamp side walls, so that it snaps into place in the side walls of the clamp.

In a preferred embodiment, the bearing bushing is designed in the form of a sleeve. The material used is reduced to a least possible amount. Moreover, a very uniform pressing of the inner bearing wall against the stabilizer bar is achieved by adapting the inner contour of the outer mount part to the contour of the bearing bushing.

In a preferred embodiment of the present invention, the outer mount part is provided at its laterally projecting wall portions with hook-shaped protrusions which snap into place in corresponding openings in the side walls of the clamp. The outer mount part may be fabricated out of a plastic, which gives it the requisite flexibility for insertion between the side walls of the clamp and engagement into the corresponding openings.

A further advantage derived from the outer part is that it can allow the force exerted by the bearing, together with the stabilizer, when it is pressed into the clamp, to be distributed very selectively over the mount.

To reinforce the positional retention of the bearing bushing in the clamp, the bearing bushing can feature a bulge in the region embraced by the clamp. The contour of the clamp is adapted to this bulge. This prevents any axial displacement of the bearing bushing inserted in the clamp. The region of the bearing bushing where it is gripped by the outer mount part may remain tubular in shape.

The bearing bushing may be provided with a slotted tube that is embedded in the elastomer. This makes it possible to influence the rigidity of the bearing.

The axial slit in the bearing bushing may be preferably placed on the side facing away from the outer mount part. When the mount is manufactured, the bushing is opened in the region of the slit, i. e., the wall portions forming the slit are spaced apart from one another. This allows for easy insertion of the stabilizer rod into the bearing.

### BRIEF DESCRIPTION OF THE DRAWING

The present invention is described in greater detail on the basis of the drawings, in which:

FIG. 1 shows a mount in a perspective view;

FIG. 2 shows a cross section through the median plane of a mount;

FIG. 3 shows a longitudinal section through a mount; and

FIG. 4 shows a bearing bushing including the outer mount part in cross section;

FIG. 5 shows a slotted tube in a perspective view.

### DETAILED DESCRIPTION OF THE EMBODIMENTS

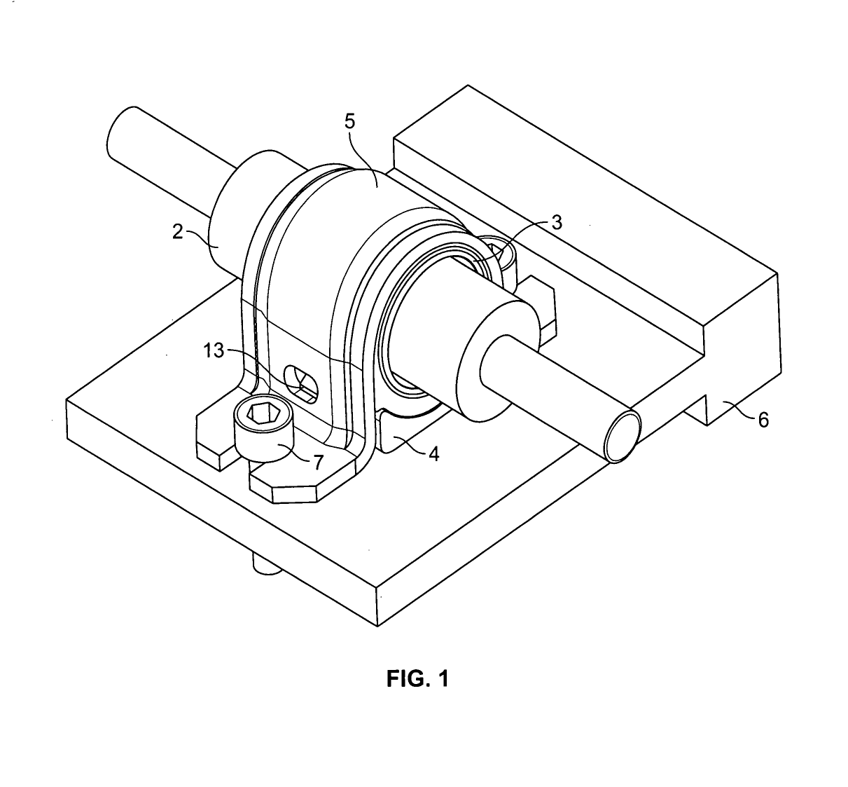

Stabilizer mount 1 shown in FIG. 1 essentially includes bearing bushing 3 that surrounds stabilizer rod 2, and outer mount part 4, which are secured by clamp 5 via screws 7 to body section 6 or the axle part.

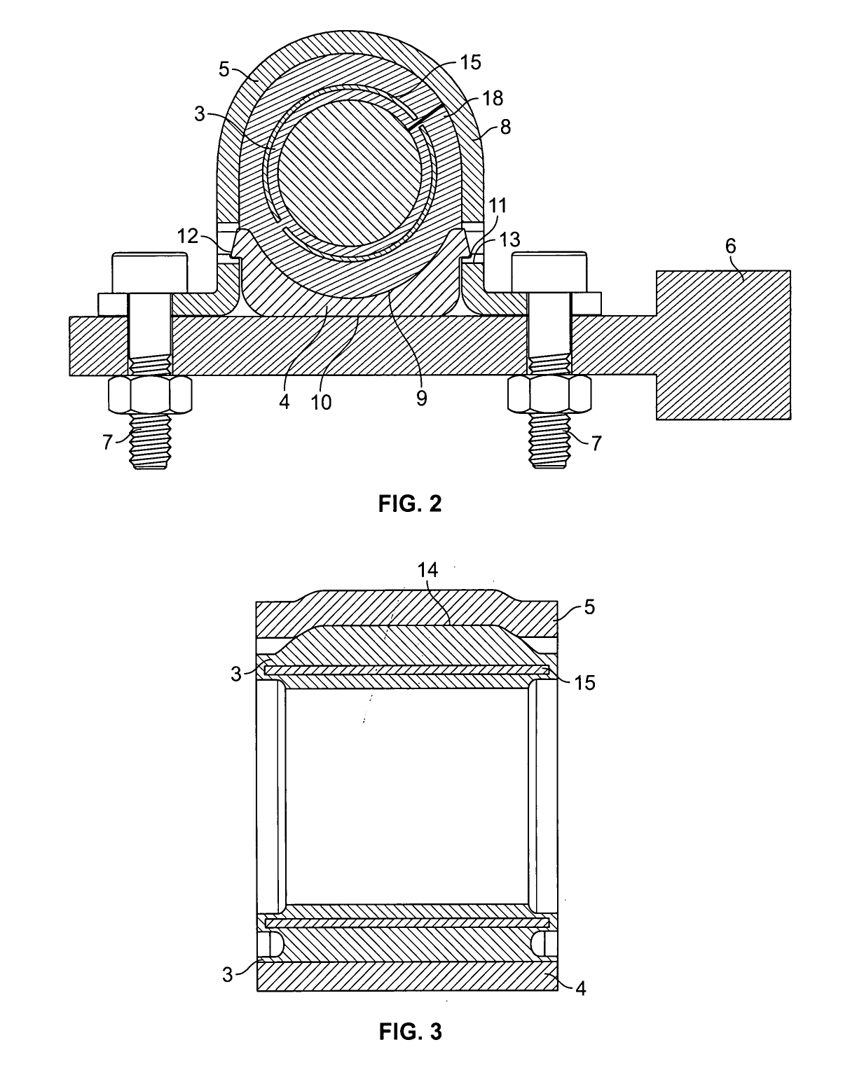

FIG. 2 shows the mount in cross section. Bearing bushing 3 has approximately the form of a sleeve. The upper portion of clamp 5 is semicircular. Its inner wall rests against bearing bushing 3. Side walls 8 of clamp 5 extend orthogonally to the fastening plane on body section 6 or the axle part. The wall of clamp 5 fits closely on the outer wall of bearing bushing 3, which may be slightly larger in its diameter. Inner contour 9 of outer mount part 4 is adapted to bearing bushing 3 and may be circular in this section. Outer contour 10 of outer mount part 4 has a planar form and rests over its entire width against body section 6. The projecting wall portions 11 of outer mount part 4 are provided with hook-shaped protrusions 12 which snap into place in openings 13 in side walls 8 of clamp 5. Outer mount part 4 may be fabricated from plastic and may be dimensionally sized for holding and securing bearing bushing 3 in clamp 5, as well as, for height adjustment purposes.

FIG. 3 shows a longitudinal section through mount 1. Bulge 14, as shown in FIG. 3, may be configured on bearing bushing 3 in its region gripped by clamp 5. Clamp 5 may be correspondingly shaped to prevent any axial displacement of clamp 5 and of bearing bushing 3. Such a configuration of bearing bushing 3 and outer mount part 4 is not required in the region of bearing bushing 3 gripped by outer mount part 4. Here, the parts may be designed without a bulge, as shown in FIG. 3. Slotted tubular member 15, which is used to stiffen the elastomer, is inserted into the elastomer of bearing bushing 3.

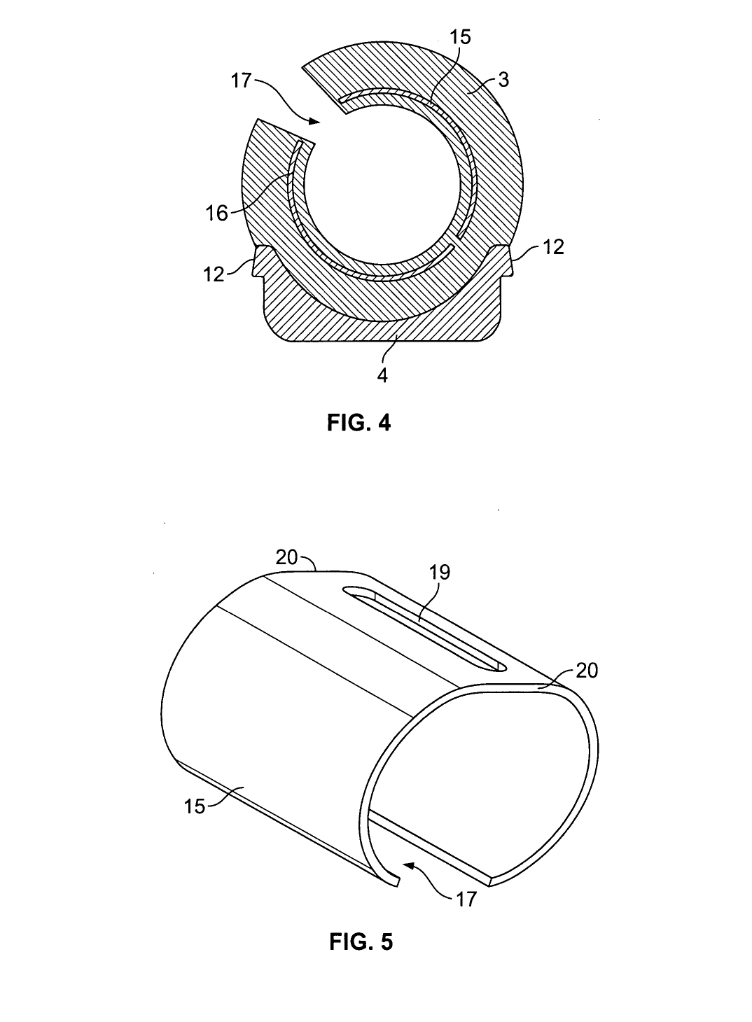

The design and placement of tubular member 15 are shown in FIGS. 4 and 5. FIG. 4 shows the shape of bearing bushing 3. Evident on the side of bearing bushing 3 facing away from outer mount part 4 is longitudinal gap 17, which is closed during assembly of the mount when bearing bushing 3 is press-fitted into clamp 5. This press-fitting action is accomplished by outer mount part 4 which engages by hook-shaped protrusions 12 into lateral openings 13 in clamp 5. Longitudinal gap 17 is closed, and slit 18 shown in FIG. 2 remains. FIG. 5 shows a perspective view of tube 15. Tubular member 15 is slotted in the longitudinal direction. Gap 17 is formed by upwards bending of tubular member 15. In this regard, see also FIG. 4. On the side opposite gap 17, tubular member 15 has a longitudinal recess 19, which extends up to the two end regions 20 over virtually the entire length of tubular member 15.

What is claimed is:

1. A stabilizer mount comprising:
a bearing bushing surrounding a stabilizer bar, the bearing bushing made of an elastomer, and having an axial slit;
a fixing clamp embracing the bearing bushing; and
an outer mount retaining the bearing bushing in the clamp, the outer mount being connectable to the clamp in form fitting relation therewith.

2. The stabilizer mount as recited in claim 1 wherein the bearing bushing has the form of a sleeve.

3. The stabilizer mount as recited in claim 2 wherein the outer mount part has an inner contour adapted to a contour of the bearing bushing.

4. The stabilizer mount as recited in claim 1, wherein the outer mount part has laterally projecting wall portions provided with hook-shaped protrusions snapping into place in openings in side walls of the clamp.

5. The stabilizer mount as recited in claim 1 wherein the outer mount part is made of a plastic.

6. The stabilizer mount as recited in claim 1 wherein the bearing bushing has a bulge in a region embraced by the clamp.

7. The stabilizer mount as recited in claim 1 wherein the bearing bushing has a tubular region gripped by the outer mount part.

8. The stabilizer mount as recited in claim 1 wherein the bearing bushing includes a tubular member longitudinally slotted on one side embedded in the elastomer.

9. The stabilizer mount as recited in claim 8 wherein, on the side opposite the axial slit, the tubular member has a longitudinal recess.

10. The stabilizer mount as recited in claim 9 wherein the longitudinal recess covers at least three-fourths of the length of the tubular member.

11. The stabilizer mount as recited in claim 1 wherein the axial slit in the bearing bushing is placed on a side facing away from the outer mount part.

12. The stabilizer mount as recited in claim 1 wherein the stabilizer mount is for coupling the stabilizer bar to a motor vehicle.
